(19) United States
(12) Patent Application Publication
(10) Pub. No.: US 2012/0019007 A1
(43) Pub. Date: Jan. 26, 2012

(54) METHOD AND APPARATUS FOR MINIMIZING HARMONIC CURRENTS IN A WIND TURBINE PARK

(76) Inventors: Robert J. Nelson, Orlando, FL (US); Hongtao Ma, Orlando, FL (US)

(21) Appl. No.: 12/840,398

(22) Filed: Jul. 21, 2010

(51) Int. Cl. H02P 9/04; H02J 3/00

(52) U.S. Cl. 290/1 R; 307/83; 290/55

(57) ABSTRACT

A collector system (49) for supplying electrical energy to a grid (50). The collector system (49) comprises a plurality of voltage sources (46/48/66/68) each producing a fundamental frequency current and a plurality of harmonic frequency currents related to the fundamental frequency, wherein one or more of the plurality of fundamental frequency currents have a time displacement relative to a current on the collector system (49), each one of the plurality of voltage sources (46/48/66/68) connected to the collector system (49) through a transformer (51/52/70), certain ones of the transformers (51/52/70) imparting a phase angle shift to compensate for the time displacement of the fundamental frequency current produced by each voltage source (46/48/66/68), and wherein the time displacement and the phase angle shifts are selected to reduce harmonic currents on the collector system (49).

### FIELD OF THE INVENTION

The present invention relates generally to minimizing harmonic currents in a wind turbine park.

### BACKGROUND OF THE INVENTION

FIG. 1 illustrates components of an exemplary variable speed wind turbine 8, including rotor blades 12 for converting wind energy to rotational energy for driving a shaft 16 connected to a gearbox 18. The wind turbine also includes a structural support component, such as a tower and a rotor pointing mechanism, not shown in FIG. 1. The gearbox 18 converts low speed rotation to high speed rotation, as required for driving a generator 20 to generate electricity.

Electricity generated by the generator 20 is supplied to a power electronics system 24 to adjust the generator output voltage and/or frequency for supply to a grid 28 via a step-up transformer 30. The low-voltage side of the transformer is connected to the power electronics system 24 and the high-voltage side to the grid 28. Generally, the power electronics system imparts characteristics to the generated electricity that are required to match electricity flowing on the grid, including controllable active power flow and voltage regulation and improved network voltage stability. Typically, a plurality of such wind turbines 8 are sited at a common location, referred to as a wind turbine park.

One embodiment of the power electronics system 24 is illustrated in FIG. 2, including a generator-side converter 40 for converting the generated AC electricity to DC and an output capacitor 42 for filtering the DC current. DC current is supplied to a line side converter 44 (inverter) for producing 60 Hz AC power supplied to the grid 28. The amount of power available from the wind turbine is determined by operation of the generator-side converter.

One type of converter employed in a variable speed wind turbine, referred to as a full converter or back-to-back converter, comprises a power converter connected to the generator side, a DC link and a power converter connected to the grid. The full converter converts an input voltage, i.e., a fixed frequency alternating current, a variable frequency alternating current (due to the variable wind speed) or a direct current, as generated by the wind turbine, to a desired output frequency and voltage as determined by the grid that it supplies. Typically using thryistors, the full converter converts the electricity produced by the generator to DC and transfers this energy to the DC link. From the DC link the electricity is supplied to the grid-side active converter where it is transformed to fixed frequency AC electricity and supplied to the grid. FIG. 2 depicts elements of a full converter.

The generation of harmonic currents is a common problem in wind parks, particularly in those parks where the individual wind turbines use full converters. Converters generate harmonic voltages that contain slight imperfections. The imperfections can be characterized as harmonic voltages that are added to the fundamental frequency waveform, as understood by those familiar with power generation. The harmonic voltages are integer multiples of the voltage at the fundamental frequency, i.e. if the fundamental frequency is f, the harmonics have frequencies of 2f, 3f, 4f, . . . etc, where the numerical value (e.g., 2, 3, 4, etc.) is referred to as the order of the harmonic.

Even if the harmonic currents from the converters comply with the applicable harmonic standards, these harmonic currents can damage power system components if the harmonic currents are concentrated in certain components. In some wind parks, the harmonic currents may result from excitation of inductive and capacitive components. For example, resonant oscillations may occur between the leakage inductance of a transformer and the capacitance of capacitors in the park and/or of the cable capacitance. These resonances can occur between any components with an inductance, such as overhead or underground transformers, reactors, etc. and a capacitance, such as a capacitor, transformer, underground cable, overhead transmission line, etc.

A feeder, also referred to as a collector, connects several wind turbines in the wind turbine park. Such feeders also connect the wind turbine park to a grid substation. The collectors function as the distribution system for the wind turbine park. Each collector is connected to the substation by one or more transformers that impart a phase shift to the wind turbine-supplied electricity, typically a 30 degree phase shift for a wye-delta transformer. Other available delta-wye phase shifts are 90 degrees and 150 degrees.

For example, a standard transformer is referred to by reference part number, Dyn 11, where the “D” refers to a delta high-voltage connection, the “y” refers to a wye low-voltage connection, the “n” indicates an accessible neutral point on the low-voltage winding and “11” indicates that the low voltage lags the high voltage by 330 electrical degrees (11×30=330). Equivalently, the low voltage leads the high voltage by 30 degrees. It is also possible to utilize the same delta-wye arrangement to impart a phase shift of 30 degrees, 150 degrees, and 210 degrees, in lieu of the 330 degrees phase shift. These phase shifts are standard vector arrangements that can be specified in a transformer specification.

If the voltages generated by park wind turbines consisted only of fundamental voltages, i.e., no harmonic components, any transformer could be used to connect the wind turbines to the grid. In many current installations, to simplify the park components, a single transformer vector arrangement is used for all transformers in the park.

### BRIEF DESCRIPTION OF THE DRAWINGS

The invention is explained in the following description in view of the drawings that show:

FIG. 1 is a block diagram of a prior art variable speed wind turbine system.

FIG. 2 is block diagram of the prior art power electronics system of FIG. 1.

FIG. 3 is a first illustration of a wind turbine park employing the principles of the present invention.

FIG. 4 is a second illustration of a wind turbine park employing the principles of the present invention.

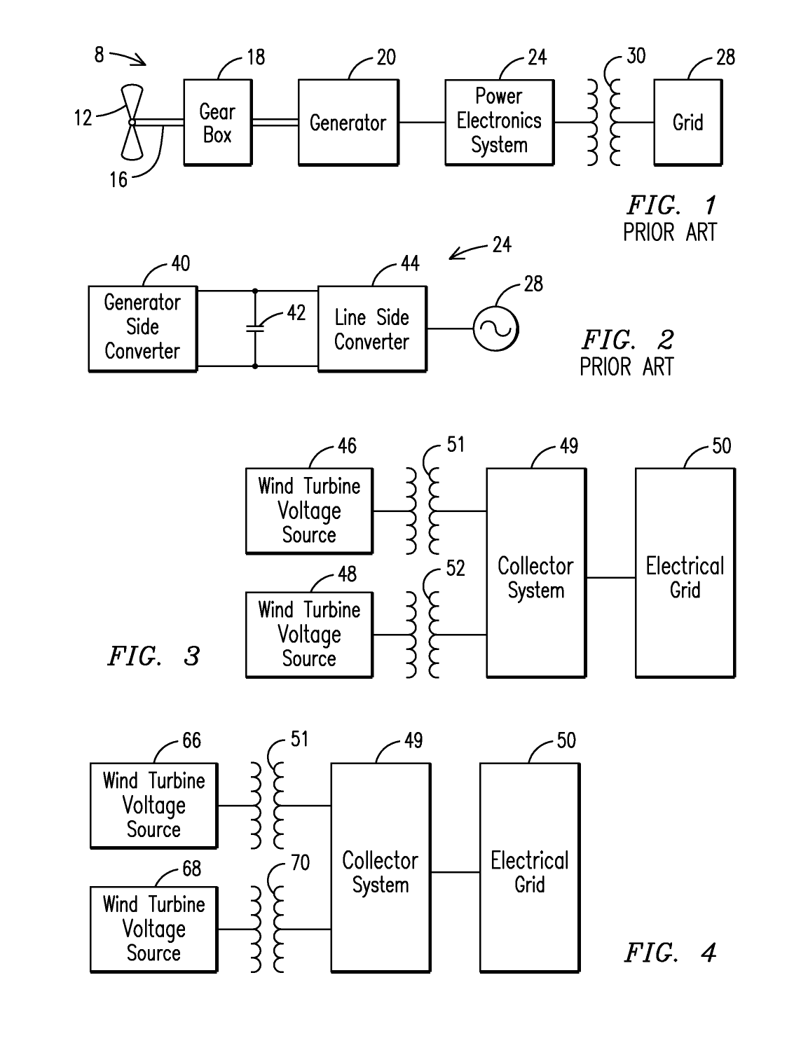

### DETAILED DESCRIPTION OF THE INVENTION

Before describing in detail the particular methods and apparatuses related to minimizing harmonics generated in a wind turbine park, in accordance with various aspects of the present invention, it should be observed that the present invention, in its various embodiments, resides primarily in a novel and non-obvious combination of hardware, method steps and software elements related to these methods and apparatuses. Accordingly, the hardware, method steps and software elements have been represented by conventional elements in the drawings, showing only those specific details that are pertinent to the present invention so as not to obscure the disclosure with structural details that will be readily apparent to those skilled in the art having the benefit of the description herein.

The following embodiments are not intended to define limits of the structures or methods of the invention, but only to provide exemplary constructions. The embodiments are permissive rather than mandatory and illustrative rather than exhaustive.

It is known by those skilled in the art that selection of a single transformer vector arrangement for all transformers in the wind park can impact the magnitude of the harmonic currents (and voltages) circulating in the wind park and transferred to the gird through the feeders. The present invention limits these electrical harmonic currents (and voltages) by using step-up transformers selected to minimize (and in certain embodiments cancel) the harmonic currents. By judiciously selecting the phase angle imparted by step-up transformers that connect the wind turbines to the system grid, certain harmonic currents generated in the park cancel other harmonic currents (i.e., because the currents are 180 degrees out-of-phase). This is accomplished without limiting the harmonic current output of individual wind turbines and ideally without affecting the fundamental frequency currents.

To ensure that the fundament currents are all in-phase and therefore can be arithmetically added on the collector system, the time displacement for electricity generated by a wind turbine and the phase angle shift imparted by a transformer that connects the wind turbine to the collector must cancel. Wind turbine generators that are not synchronized cause the time displacement or time shift. For a transformer imparting a +30 degree phase angle shift, the fundamental current generated by the wind turbine must have a −30 degree time shift to cancel the transformer phase shift. The phase angle shift imparted by the transformer has to correct for the time displacement of the generated fundamental waveform to permit arithmetic addition of fundamental currents on the collector system.

Although not explicitly discussed herein, it is assumed that the wind turbines generate three phase electricity, with the three phase currents (a, b, and c) (or voltage) displaced by 120 degrees. A positive sequence rotation exists when the three phase currents are in an (a, b, c) sequence; a negative sequence (backward) rotation exists when the phase currents are in an (a, c, b) sequence; a zero sequence set exists if all three currents are in phase (a, a, a).

Note also that the wind turbines illustrated in FIGS. 3 and 4 and described below are configured in an electrically parallel arrangement. Thus if the currents generated by the two generators are in phase, they are summed to determine the total current. But the voltages are not added. If the output voltage of the two sources is the same, e.g., V=1, then the voltage of the combination is also V=1. Finally, a phase shift associated with a voltage is also associated with a current generated from the voltage as expressed by the equation I=V/Z.

Consider two wind turbine voltage sources (wind turbine generators) 46 and 48 connected in parallel in a wind turbine park. See FIG. 3. Both voltage sources 46 and 48 generate a voltage with a time displacement of 1/12^{th} cycle or 30 electrical degrees advanced with respect to the voltage on a collector system 49. That is, the wind turbines 46 and 48 each generate a voltage that leads the collector voltage by 30 electrical degrees. The collector system is connected to an electrical grid 50. Each voltage source 46 and 48 is connected to the collector system 49 by a respective step-up transformer 51 and 52. Each transformer comprises a delta high-voltage connection, a wye low-voltage connection, and an accessible neutral point, with the high voltage winding retarding the phase of the turbine-generated fundamental voltage by 30 electrical degrees.

Since each of the generated voltages leads the collector system voltage by 30 degrees and each of the transformers causes the high voltage to lag the low voltage by 30 electrical degrees, the voltages appearing on the collector system 49 as generated by the wind turbine voltage sources 46 and 48 are in phase at 0 degrees. This relationship applies to the fundamental frequency voltages and all harmonic voltages. The fundamental current and all the harmonic currents are also all in phase. Thus the harmonic currents add arithmetically, i.e., the harmonic current output of the two voltage sources is exactly twice the output from either source.

Since the fundamental and the harmonics are in phase and add arithmetically, there is no cancellation of the harmonic currents. Thus harmonic currents are still present on the collector system 49 and fed to the grid 50.

Consider two other wind turbine voltage sources 66 and 68 connected in parallel in a wind turbine park. See FIG. 4. The voltage source 66 generates a voltage that is 30 degrees advanced with respect to the collector system voltage and is connected to the system through the step-up transformer 51, which causes the phase of the voltage appearing on the collection system to lag 30 degrees behind the voltage of the turbine.

The voltage source 68 generates a voltage in-phase with the collector system and is connected to the collector system through a wye-wye step up transformer 70 with a delta tertiary or a grounded zigzag-delta secondary winding that imparts no phase angle shift between the primary and secondary windings.

At the fundamental frequency, the voltages from the two sources are 30 degrees out of phase as they exit their respective generators, but are in phase on the collector system 49 due to the −30 degrees phase angle shift imparted by the transformer 51 to the fundamental voltage from the voltage source 66. The fundamental currents from the two wind turbine generators are also in phase on the collector system 49.

The 1st (fundamental), 2^{nd}, 3^{rd} 4^{th}, 5^{th}, 6^{th}, 7^{th}, etc., voltage harmonics at the wind turbine voltage source are, respectively, positive sequence, negative sequence, zero sequence, positive sequence, etc. The positive sequence voltages and currents are those harmonics that satisfy the relationship, m=3n+1 (where n=1, 2, 3, . . . ), the negative sequence harmonics are those that satisfy the relationship, m=3n−1 (where n=1, 2, 3, . . . ) and the zero sequence harmonics are those that satisfy the relationship, m=3n (where n=1, 2, 3, . . . ). If the transformer 51 imparts a −30 degrees phase angle shift to the fundamental (a positive sequence voltage), then it imparts a +30 degrees phase angle shift to the negative sequence 2^{nd} harmonic, no phase angle shift to the zero sequence 3^{rd} harmonic, a −30 degrees phase angle shift to the positive sequence 4^{th} harmonic, etc. The transformer 51 imparts the same −30 degree phase angle shift to all positive sequence harmonic voltages and currents, a +30 degree phase shift to all negative sequence harmonic voltages and currents. No phase angle shift is imparted for the zero sequence voltages and currents.

Considering the +30 degrees time displacement of the voltage source 66, the phase angles of the harmonic voltages from the voltage source 66 at the wind turbine output are:

1^{st} harmonic (fundamental): 1×(+30)=+30

2^{nd} harmonic: 2×(+30)=+60

3^{rd} harmonic: 3×(+30)=+90

4^{th} harmonic: 4×(+30)=+120

5^{th} harmonic: 5×(+30)=+150 etc.

Transforming the output voltage from wind turbine voltage source to the collector system, the corresponding voltages and currents receive an additional phase shift of +30, 0, or −30 degrees (by the transformer 51), depending on whether the current/voltage is negative, zero, or positive sequence, respectively. Consequently, the voltages and currents of the fundamental and the harmonics, as transformed to the collector system, are:

1^{st} harmonic (fundamental): +30−30=0 positive sequence

2^{nd} harmonic: +60+30=+90 negative sequence

3^{rd} harmonic: +90 +0=+90 zero sequence

4^{th} harmonic: +120−30=+90 positive sequence

5^{th} harmonic: +150+30=+180 negative sequence etc.

In general, for any harmonic voltage and current displaced in time by α electrical degrees from a reference, each harmonic is displaced by mα degrees, where m is the order of the harmonic. Using the collector voltage as reference (0 degrees), the source can be connected to the collector by a transformer with a phase shift of −α degrees in the fundamental and for all positive sequence harmonics. The corresponding phase shift for negative sequence harmonics is +α, and there is no phase shift for zero sequence harmonics.

Continuing the example, since the voltage source 68 generates an in-phase voltage and no transformer phase shift is present in the path to the collector system, the 2^{nd}, 3^{rd}, 4^{th}, 5^{th}, etc. harmonics generated by the source 68 encounter no phase angle shift. Transformed to the collector system, the 2^{nd}, 3^{rd} and 4^{th} harmonic currents provided to the collector system from the two voltage sources 66 and 68 (i.e., the like-order harmonic currents) are all +90 degrees out of phase, as indicated in the calculations above. The fundamental quantities are in-phase, as also indicated in the calculations above.

Adding the harmonic currents vectorially, reduces, but does not eliminate, the total magnitude of the 2^{nd}, 3^{rd} and 4^{th} harmonics on the collector system 49 and the grid 50. If the magnitude of the 2^{nd} harmonic current from voltage source 66 (transformed to the collector system) is 1 unit, for example, and the corresponding quantity from voltage source 68 is also 1 unit, the total current appearing on the collector system from the two voltage sources is 1.414 units, because the two are in quadrature (i.e., total current=|1+j1|=√2 amperes). This value is of course less than an arithmetic sum of 2, but greater than a complete cancellation and a vector sum of 0.

Consider the 5^{th} harmonic voltage. As indicated in the calculations above for the negative sequence 5^{th} harmonic, the transformer imparts a +30 degrees phase angle shift. Also for the 5^{th} harmonic, the voltage from the generator or voltage source 66 is 5×(+30)=150 electrical degrees. The total phase shift for the 5^{th} harmonic current is +180 degrees or 180 degrees leading with respect to the current reaching the collector system from the voltage source 68. The 5^{th} harmonic voltage from the source 68 is in phase with the collector system reference. Therefore on the collector system 49, the 5^{th} harmonic currents from the sources 66 and 68 (i.e., the like-order harmonic currents) are 180 degrees out of phase and cancel.

Similarly, the 7th harmonic voltage from the voltage source 66 leads the system reference by 210 degrees (7×30). Since the 7th harmonic is a positive sequence harmonic component, the transformer imparts a phase shift of −30 degrees (same phase shift as the fundamental frequency). The 7th harmonic voltage (from the source 66) on the collector system is 180 degrees out of phase with the system reference (210 degrees−30 degrees). The 7th harmonic voltage appearing on the collector system from the source 68 is in phase with the system reference. Consequently, the 7th like-order harmonic currents cancel and there is no net 7th harmonic current on the collector system, even though each converter generates a 7^{th} harmonic current.

These concepts can be generalized to a wind turbine park where all wind turbines generate essentially identical fundamental frequency voltages with half operating at a 30 degrees time shift relative to the other wind turbines. The wind turbines operating with the time shift operate through a transformer that imparts a 30 degrees phase angle shift. The other wind turbines do not operate through a phase-shifting transformer. In this configuration, very little 5th and 7th harmonic currents appear at the park output, even though individual wind turbines continue to generate harmonic currents.

In practice, the concepts of the invention can be ideally implemented on two wind turbine generators that are substantially matched electrically, e.g., providing substantially the same output power at substantially the same voltage with minimal reactance between the two turbines. But in practice, two wind turbine generators may not generate the same voltage nor see the same harmonic impedance, so the perfect cancellation described above may represent an ideal situation and may not be attainable in practice. But use of the present invention clearly results in a considerable reduction in the harmonic components in the wind turbine park and further facilitates compliance with applicable harmonic standards, such as IEEE 519.

Also, the references above to a 30 electrical degrees phase angle difference (or time shift) between the output of the voltage sources 66 and 68 is merely exemplary. The principles of the present invention can be successfully applied to any situation with a different phase angle difference to reduce the harmonic content on the collector system and on the electrical grid by judicious selection of the phase angle shift imparted by a transformer that connects one or both voltage sources to the collector system.

As shown below, the scheme described above has no impact on the 11th and the 13th harmonic currents, but it eliminates the 17th and 19th (6n+/−1) harmonics according to the same principles as described above for eliminating the 5^{th} and 7^{th} harmonics.

The 11^{th} and 13^{th} harmonics are respectively negative sequence and positive sequence. The transformer 51 imparts a +30 degrees phase angle shift to the 11^{th} harmonic and a −30 degrees phase shift to the 17^{th} harmonic. Also considering the +30 degrees time displacement of the voltage source 66, the phase angle of the harmonic voltages are:

11^{th} harmonic: 11×(+30)+30=360=0

13^{th} harmonic: 13×(+30)−30=360=0

Since the voltage from the voltage source 68 is at 0 degrees (or in phase with the collector voltage), the 11^{th} and 13^{th} harmonics from the two voltage sources are not cancelled according to this scheme, but instead are in phase.

The 17^{th} and 19^{th} harmonics are respectively negative sequence and positive sequence. The transformer 51 imparts a +30 degrees phase angle shift to the 17^{th} harmonic and a −30 degrees phase shift to the 19^{th} harmonic. Also considering the +30 degrees time displacement of the voltage source 66 and the harmonic number, the phase angle of the harmonic voltages on the collector system 49 are:

17^{th} harmonic: 17×(+30)+30−360=180

19^{th} harmonic: ×(+30)−30−360=180

Again, the voltage from the voltage source 68 is at 0 degrees (or in phase with the collector voltage). The 17^{th} and 19^{th} harmonics from the two voltage sources are 180 degrees out-of-phase on the collector system and cancel according to this scheme.

The present application describes the use of various phase angle shifts among wind turbine generator transformers to minimize harmonic currents within the wind park, with no diminution in the output at the fundamental frequency.

A preferred embodiment minimizes the 5th and 7th harmonics according to the techniques described above. However, other embodiments can address other phase shift combinations to reduce or minimize the total harmonic distortion (THD) or to reduce or eliminate targeted harmonics, such as the 11th and 13^{th} harmonics.

For example, consider a voltage source that generates one unit (measured in amperes or otherwise) of harmonic current in the 5^{th}, 7^{th}, 11^{th}, and 13^{th} harmonics. If there are three such sources, each interfaced to the collector system by identical transformers, the harmonic current output (i.e., considering only the four identified harmonics) of each source is four units and the source currents add arithmetically, supplying twelve units of harmonic current to the collector system.

Assume the three sources are configured to produce three different time shifts, corresponding to 0, +15, and +30 electrical degrees, respectively, relative to the collector system reference, and the three sources are interfaced to the collector system by a transformer, each supplying a phase shift of 0, −15, and −30 degrees, respectively. Using the principles outlined above, the total harmonic current (i.e., considering only the four identified harmonics) is reduced to a total of about 2.8 units (less than the total harmonic current output of a single turbine), which is a reduction of more than 70%.

By using different phase shifts in the transformers connecting each voltage source (wind turbine) to the wind park and considering the time displacement of one wind turbine generator with respect to another, it is possible to eliminate or at least reduce various harmonic current combinations. Specific phase shift/time displacements can be employed to minimize total current harmonic distortion or to target specified harmonics of concern. Generally, the principals of the invention can be practiced to cancel like-order harmonics that are expressed according to the equations, (6n+1) and (6n−1), where n=2, 3, 4, 5, 6, 7, etc., i.e. any positive integer other than 1. As described herein, the time shifts and phase shifts must be properly selected to cancel the like-order harmonics. Implementation of the scheme of the present invention reduces the need for harmonic filters on wind turbine park conductors, particularly for wind turbines employing full converters.

As those skilled in the art recognize, the time displacement can be adjusted, with corresponding phase angle shifts imparted by the transformers, to eliminate or at least reduce combinations of like-order harmonic currents.

As a practical matter, however, the most difficult problems with the harmonic components are associated with low phase-order odd non-triplen harmonics because they are difficult and expensive to filter and can be excited over long distances. In most applications, eliminating the 5th and 7th harmonics (generally the most troublesome ones) is adequate. The 11th and 13th (and higher) harmonics are often shunted to ground by collector cable capacitance and blocked by transformers, so they are less likely to be an issue at a point of interconnection to the grid.

Although application of the principles of the present invention may not eliminate all harmonics on the, collector system, it is know that triplen harmonics (multiples of 3) are usually blocked by a transformer delta winding. It is also known that even harmonics do not normally appear in the converter output at significant levels, though they can be minimized by this technique, as well, if desired.

According to another embodiment, non-standard transformer phase shifts are used to further minimize total harmonic output. For example, if the two voltage sources are phase shifted by 15 degrees, the resulting configuration cancels the 11th and 13th harmonic currents, without reducing the 5th and 7^{th} harmonic currents. A 15 degree phase shift in a transformer may necessitate a design that is not commonly used in power transformers.

The inventors believe that the harmonic cancellation apparatuses and methods described above will cost little if standard transformers are used, with only a slight increase for non-standard transformers. It is noted that the cost of a step-up transformer for a wind turbine generator is about 1% of the cost of the wind turbine generator.

According to the present invention, depending on the output harmonic spectra of the wind turbines and the park requirements, the time displacements and phase shifts can be optimized to minimize the total harmonic distortion or reduce specific harmonics of interest. Although ideally all the fundamental frequency currents are in phase on the collector system, it may be desirable to trade-off in-phase fundamental currents for the reduction of certain harmonic currents, by adjusting the time displacement and/or the phase angle shift imparted by the transformers.

The principles of the invention can also be generalized to apply to angles other than 30 electrical degrees, as set forth in certain examples presented above, and to the use of multiple angles (e.g., three or more different phase angles) to generally reduce harmonic currents on the collector system.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A collector system for supplying electrical energy to a grid, the collector system comprising:
a plurality of voltage sources each producing a fundamental frequency current and a plurality of harmonic frequency currents related to the fundamental frequency, wherein one or more of the plurality of fundamental frequency currents have a time displacement relative to a current in the collector system;
each one of the plurality of voltage sources connected to the collector system through a transformer, certain ones of the transformers imparting a phase angle shift to compensate for the time displacement of the fundamental frequency current produced by each voltage source; and
wherein the time displacement and the phase angle shifts are selected to reduce harmonic currents in the collector system.

2. The collector system of claim 1 wherein the time shifts and the phase angle shifts are selected to cause the fundamental frequency currents to be substantially in phase in the collector system.

3. The collector system of claim 1 wherein the time shifts and the phase angle shifts are selected to cause a vector sum of certain like-order harmonic currents to substantially cancel in the collector system.

4. The collector system of claim 3 wherein the like-order harmonics comprise the 5^{th} harmonic currents and the 7^{th} harmonic currents.

5. The collector system of claim 3 wherein the like-order harmonics comprise a (6n−1) and (6n+1) pair, where, n is any positive integer other than 1.

6. The collector system of claim 1 wherein certain like-order harmonic currents are out-of-phase in the collector system and when added vectorially in the collector system produce a vector sum that is less than an arithmetic sum.

7. The collector system of claim 1 wherein the time displacements and the phase angle shifts are selected to cause the fundamental frequency currents to be substantially in phase in the collector system, to cause a vector sum of certain like-order harmonic currents to substantially cancel in the collector system and to cause a vector sum of other like-order harmonic currents to be out-of-phase in the collector system such that when added vectorially the other like-order harmonic currents produce a vector sum that is less than an arithmetic sum, and wherein selected phase angle shifts comprise at least two different phase angle shifts.

8. The collector system of claim 7 wherein selected time displacements comprises at least two different time displacements.

9. The collector system of claim 1 wherein the voltage sources comprise wind turbine generators or photovoltaic sources.

10. A wind turbine collector system for producing electrical energy for supply to a grid, the wind turbine park comprising:
a first wind turbine generator producing a first fundamental frequency current and a first plurality of harmonic frequency currents related to the first fundamental frequency;
a second wind turbine generator connected in parallel with the first wind turbine generator and producing a second fundamental frequency current and a second plurality of harmonic frequency currents related to the second fundamental frequency;
the first and second wind turbine generators connected to a collector system through a respective first and second transformer;
wherein the first fundamental frequency current has a time displacement relative to the second fundamental frequency current;
wherein one or both of the first transformer and the second transformer impart a phase angle shift to one or more of the first fundamental frequency current, individual ones of the first plurality of harmonic frequency currents, the second fundamental frequency current and individual ones of the second plurality of harmonic frequency currents;
wherein in the collector system the first and the second fundamental frequency currents are substantially in phase; and
wherein in the collector system certain ones of the first plurality of harmonic currents cancel like-order harmonics from among the second plurality of harmonic currents.

11. The wind turbine collector system of claim 10 wherein the first and the second wind turbine generators generate substantially the same output power at substantially the same voltage.

12. The wind turbine collector system of claim 10 wherein the time shift and the phase angle shift are selected to cause certain harmonic currents from the first plurality of harmonic frequency currents and like-order harmonic currents from the second plurality of harmonic currents to be substantially 180 electrical degrees out of phase in the collector system.

13. The wind turbine collector system of claim 10 wherein the time displacement is plus or minus N degrees, and wherein N is a value less than 360 degrees, and wherein the first and the second transformers provide a net minus or plus N degrees of phase angle shift such that in the collector system the first and the second fundamental frequency currents are substantially in phase.

14. The wind turbine collector system of claim 10 wherein the first and the second wind turbine generators each generate three phase voltages, the three phase voltages separated by 120 electrical degrees.

15. The wind turbine collector system of claim 10 wherein 5^{th} and 7^{th} harmonic currents from each of the first and second plurality of harmonic currents and 17^{th} and 19^{th} harmonic currents from each of the first and second plurality of harmonic currents are substantially 180 electrical degrees out of phase in the collector system.

16. The wind turbine collector system of claim 10 wherein the 11^{th} and 13^{th} harmonic currents from each of the first and second plurality of harmonic currents are substantially 180 electrical degrees out of phase on the collector system.

17. The wind turbine collector system of claim 10 wherein the first fundamental frequency current is time advanced or retarded by 1/12^{th} of a cycle from the second fundamental frequency current, and wherein the first transformer imparts a phase angle shift of minus or plus 30 electrical degrees to the first fundamental frequency current and the second transformer imparts a phase angle shift of 0 electrical degrees to the second fundamental frequency current.

18. The wind turbine collector system of claim 10 wherein in the collector system 2^{nd} and 4^{th} harmonic currents from the first plurality of harmonic frequency currents and 2^{nd} and 4^{th} harmonic currents from the second plurality of harmonic frequency currents are out of phase by a value other than 180 electrical degrees.

19. A method for producing electrical energy in a wind turbine park for supply to an electrical grid, the method comprising:
generating a first fundamental frequency current and a first plurality of harmonic frequency currents related to the first fundamental frequency from a first electric wind generation system;
generating a second fundamental frequency current and a second plurality of harmonic frequency currents related to the second fundamental frequency from a second electric wind generation system;
providing the first fundamental frequency current, the first plurality of harmonic frequency currents, the second fundamental frequency current and the second plurality harmonic frequency currents to a collector system;
imparting a phase shift to at least one of the first fundamental frequency current and the second fundamental frequency current through transformer action, such that the first and the second fundamental frequency currents are substantially in phase in the collector system, wherein the transformer action also phase shifts certain ones of the first and the second plurality of harmonic frequency currents; and
wherein in the collector system certain ones of the first plurality of harmonic frequency currents and like harmonic frequency currents from the second plurality of harmonic frequency currents substantially cancel.

20. The method of claim 19 wherein the first fundamental frequency current is time displaced relative to the second fundamental frequency current.

21. The method of claim 20 wherein the time displacement is plus or minus N degrees, and wherein N is less than 360 degrees, and wherein the transformer action provides a net minus or plus N degrees of phase angle shift such that in the collector system the first and the second fundamental frequency currents are substantially in phase.

22. The method of claim 19 wherein the step of generating the first fundamental frequency current and the step of generating the second fundamental frequency current each generate phase a, phase b and phase c currents separated by 120 electrical degrees.

23. The method of claim 19 wherein in the collector system 5^{th} and 7^{th} harmonic frequency currents from the first plurality of harmonic frequency currents and 5^{th} and 7^{th} harmonic frequency currents from the second plurality of harmonic frequency currents are substantially 180 electrical degrees out of phase.

24. The method of claim 19 wherein in the collector system 11^{th} and 13^{th} harmonic frequency currents from the first plurality of harmonic frequency currents and 11^{th} and 13^{th} harmonic frequency currents from the second plurality of harmonic frequency currents are substantially 180 electrical degrees out of phase.

25. The method of claim 19 further comprising:
generating a third fundamental frequency current and a third plurality of harmonic frequency currents related to the third fundamental frequency from a third electric generator rotatably coupled to rotor blades of a third wind turbine, wherein wind energy causes rotation of the rotor blades;
providing the first fundamental frequency current, the first plurality of harmonic frequency currents, the second fundamental frequency current, the second plurality harmonic frequency currents, the third fundamental frequency current and the third plurality of harmonic frequency currents to the collector system;
imparting a phase shift to at least one of the first fundamental frequency current, the second fundamental frequency current and the third fundamental frequency current through transformer action, such that the first, the second and the third fundamental frequency currents are substantially in phase in the collector system, wherein the transformer action also phase shifts one or more harmonic frequency currents from the first plurality of harmonic frequency currents, the second plurality of harmonic frequency currents, and the third plurality of harmonic frequency currents; and
wherein in the collector system certain ones of the first plurality of harmonic frequency currents and like-order harmonic frequency currents from the second plurality of harmonic frequency currents and the third plurality of harmonic frequency currents substantially cancel.
